(19) United States
(12) Patent Application Publication
(10) Pub. No.: US 2020/0088369 A1
(43) Pub. Date: Mar. 19, 2020

(54) ELECTRONICALLY VARIABLE LIGHT BEAM PATTERN FOR LIGHTING DEVICE

(71) Applicant: Koehler-Bright Star LLC, Hanover Township, PA (US)

(72) Inventors: Jeff Keisling, Clarks Summit, PA (US); Tom Pellegrini, Exeter, PA (US)

(21) Appl. No.: 16/570,077

(22) Filed: Sep. 13, 2019

Related U.S. Application Data
(60) Provisional application No. 62/730,895, filed on Sep. 13, 2018.

(51) Int. Cl. F21S 10/00; F21V 7/00; F21L 4/02; F21S 9/02

(52) U.S. Cl. CPC F21S 10/00; F21V 7/0075; F21Y 2115/10; F21S 9/02; F21L 4/027

(57) ABSTRACT

An electronically variable lighting device includes a power supply, an input device, one or more first light sources, one or more second light sources, and circuitry interconnecting the power supply and the input device with the light sources. The light sources are configured to produce a light beam shape for producing a desired light beam pattern. The circuitry is configured to control power supplied from the power supply to the one or more first light sources, the one or more second light sources, or both, to vary the light beam pattern. A method of electronically varying a light beam shape to produce a desired light beam pattern by a lighting device includes supplying power to one or more first light sources, supplying power to one or more second light sources, and varying the power supplied to the one or more first light sources, the one or more second light sources, or both.

### BACKGROUND

The present disclosure relates a lighting device, for example, a lighting device configured to produce an electronically variable light beam pattern.

Lighting devices, such as flashlights and cap lamps are typically designed to have either a central light to produce a central beam pattern or a peripheral light or lights to produce a peripheral beam pattern. A central beam pattern is typically used for illuminating objects at relatively far distances. A peripheral beam pattern is typically used for shorter distances, and wider field-of-view applications. A peripheral beam pattern typically provides softer light, less eye strain and better peripheral lighting than the central beam pattern. Accordingly, where needs and environments may vary, a user may carry multiple lighting devices having different lighting configurations to produce central beam patterns or peripheral beam patterns as needed.

For example, a firefighter may need a highly focused central beam pattern when inside of a fire with thick smoke. However, a peripheral beam pattern may be more suitable when working in areas around the fire scene, for instance, to identify potential obstacles in areas which are otherwise poorly illuminated. In another example, a utility worker may need to a see a transformer at night that is far away, thus requiring a lighting device configured to produce a central beam. However, when performing maintenance or repair, the utility worker may need a softer, more diffuse light, such as the light provided by a peripheral beam pattern.

However, the need for using multiple lighting devices results in increased equipment costs. In addition, carrying multiple lighting devices at a job site may be burdensome or cumbersome to the user. Further, switching between lighting devices may be time consuming.

U.S. Pat. No. 9,933,122 (“U.S. '122”) provides a lighting device providing both central and peripheral illumination to produce a balanced light beam pattern. To this end, U.S. '122 provides a light assembly having a light source and a reflector having a reflective interior surface and a central opening. A toroidal-shaped toroid optic includes a central bore and the light source is positioned in the central bore. The toroid optic is positioned within the central opening of the reflector. A broadening lens is attached to the reflector and positioned adjacent to the toroid optic. The broadening lens includes a central optic. While the lighting device of U.S. '122 provides a balance between central and peripheral illumination, the beam pattern is fixed for a given optic design. U.S. '122 is commonly assigned with the instant application and is incorporated herein by reference, in its entirety.

Other known lighting devices include mechanical adjustments to adjust optic components relative to the position of the light source in order to vary the beam pattern. Such mechanical adjustments include sliding or screwing mechanisms. However, the mechanical adjustments add complexity to the lighting device, and are limited in the amount of peripheral light which may be obtained. Other known lighting devices include electronically adjustable lenses configured to focus light without requiring mechanical movement of the lens itself. One such lens includes a crystalline orientation which may be varied in response to application of a voltage. Another lens, referred to as a liquid lens, includes an optical liquid material that can change shape to vary the focal length. For example, a radius of curvature of the liquid lens may be electronically controlled to vary the focal length through electrowetting or the use of shape changing polymers. However, such known lighting devices may not be portable, and/or the lenses may be relatively complex to produce and install.

Accordingly, it is desirable to provide a lighting device configured to provide a user selectable, electronically variable light beam pattern.

### SUMMARY

According to one embodiment, an electronically variable lighting device includes a power supply, an input device, one or more first light sources, one or more second light sources and circuitry interconnecting the power supply and the input device with the one or more first light sources and the one or more second light sources. The one or more first light sources and the one or more second light sources are configured to produce a light beam shape for producing a light beam pattern. The circuitry is configured to control power supplied from the power supply to the one or more first light sources, the one or more second light sources, or both, to vary the light beam shape.

The circuitry may be configured to control power supplied by the power supply to the one or more first light sources, the one or more second light sources, or both, in response to an input signal received from the input device. The one or more first light sources may be configured to produce a central, narrow light beam pattern. The one or more second light sources may be configured to produce a peripheral, flood light beam pattern. The one or more first light sources may be centrally positioned and the one or more second light sources may be peripherally positioned relative to the one or more first light sources.

The one or more first light sources and the one or more second light sources may be either coplanar or non-coplanar. The lighting device may further include a chamber. The one or more first light sources may be positioned inside the chamber and the one or more second light sources may be positioned outside of the chamber. In another embodiment, the one or more first light sources and the one or more second light sources may be positioned inside the chamber. The one or more first light sources may be spaced from the one or more second light sources in a longitudinal direction of the chamber.

In one embodiment, the circuitry may include a printed circuit board. Alternatively, or in addition, the circuitry may include a microcontroller. Power may be supplied to the one or more first light sources and the one or more second light sources independently of one another. Alternatively, power supplied to the one or more first light sources may be inversely proportional to power supplied to the one or more second light sources. The one or more first light sources, the one or more second light sources, or both, may be light emitting diodes. In another embodiment, the one or more first light sources, the one or more second light sources, or both, may be laser excited phosphor. The lighting device may include one or more optic devices configured to direct a light beam produced by the one or more first light sources, the one or more second light sources, or both. The optic device may be a reflector configured to reflect a light beam produced by the one or more first light sources, the one or more second light sources, or both. In one embodiment, the lighting device may further include a mechanical control operably coupled to the one or more first light sources, the one or more second light sources, one or more optic devices or a combination thereof. The mechanical control is operable to vary the light beam pattern.

In one embodiment, the optic device may be a lens, such as an electronically controlled lens. In one embodiment, at least one light source of the one or more first light sources or the one or more second light sources and at least one other light source of the one or more first light sources or the one or more second light sources may be oriented to emit light beams in substantially non-parallel directions relative to one another.

According to another aspect, a method of electronically varying a light beam pattern produced by a lighting device includes supplying power to one or more first light sources, supplying power to one or more second light sources, and varying the power supplied to the one or more first light sources, the one or more second light sources, or both.

These and other features and advantages of the present invention will be apparent from the following detailed description, in conjunction with the appended claims.

### BRIEF DESCRIPTION OF THE DRAWINGS

FIG. 1 a diagram showing an example of a lighting device having a first lighting array according to an embodiment;

FIG. 2 is a diagram showing an example of a light device having a second lighting array, according to an embodiment;

FIG. 3 is a schematic block diagram of a lighting device according to an embodiment;

FIG. 4 shows an example of an electronically variable light beam pattern produced by a lighting device according to an embodiment;

FIG. 5 shows another example of an electronically variable light beam pattern produced by a lighting device according to an embodiment;

FIG. 6 shows another example of an electronically variable light beam pattern produced by a lighting device according to an embodiment;

FIG. 7 is a perspective view of a lighting device according to another embodiment;

FIG. 8 is a cross-sectional view of the lighting device of FIG. 7;

FIG. 9 is an enlarged, partial cross-sectional view of the lighting device of FIG. 7;

FIG. 10 is a side view of the lighting device of FIG. 7;

FIG. 11 is a perspective view showing a portion of a lighting device according to another embodiment;

FIG. 12 is a front view of the lighting device of FIG. 11;

FIG. 13 is a front view of a lighting device according to another embodiment;

FIG. 14 is a perspective view of the lighting device of FIG. 13;

FIG. 15 is a perspective view of a lighting device according to another embodiment;

FIG. 16 is another perspective view of the lighting device of FIG. 15;

FIG. 17 is a perspective view of a lighting device according to another embodiment;

FIG. 18 is a front view of the lighting device of FIG. 17;

FIG. 19 is a perspective view of a lighting device according to another embodiment;

FIG. 20 is another perspective view of the lighting device of FIG. 19;

FIG. 21 is a perspective view of a lighting device according to another embodiment;

FIG. 22 is another perspective view of the lighting device of FIG. 21;

FIG. 23 is block diagram showing a method of electronically varying a light beam pattern produced by a lighting device, according to an embodiment; and

FIG. 24 is a transparent perspective view of a lighting device according to another embodiment.

### DETAILED DESCRIPTION

While the present device is susceptible of embodiment in various forms, there is shown in the figures and will hereinafter be described a presently preferred embodiment with the understanding that the present disclosure is to be considered an exemplification of the device and is not intended to be limited to the specific embodiment illustrated.

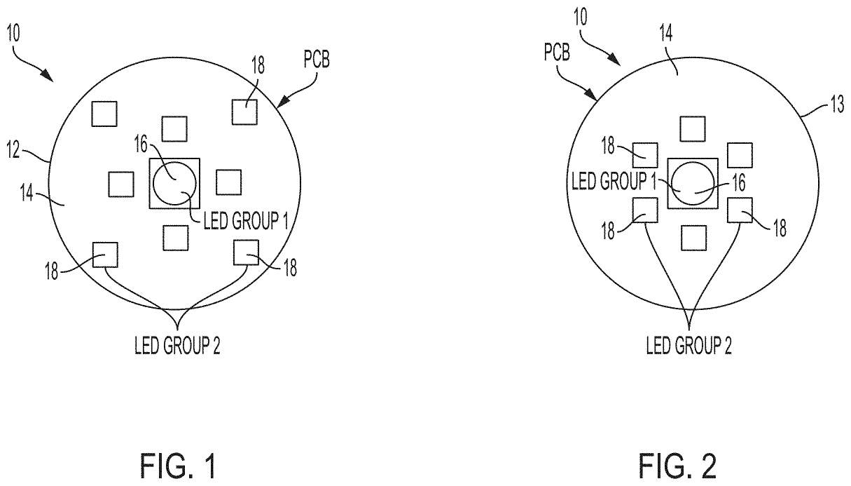

FIG. 1 is a diagram showing an example of a lighting device 10 according to an embodiment. The lighting device 10 may include one or more first light sources 16 and one or more second light sources 18 generally arranged in a first lighting array 12. In one embodiment, the first light source 16 is configured to provide a central light associated with a narrow light beam pattern. The second light source 18 is configured to provide peripheral light, associated with a flood light beam pattern. In one embodiment, the narrow light beam pattern has a smaller diameter than the flood light beam pattern when projected onto a surface at equal distances. In one embodiment, the narrow light beam pattern may have a greater intensity and/or brightness than the flood light beam pattern.

The first and second light sources 16, 18 are configured to produce a light beam shape resulting in light beam pattern having properties of the narrow light beam pattern, the flood light beam pattern, or a combination of both (which may be referred to herein as a combined light beam pattern). In the embodiments described herein, the light beam shape may generally refer to shape of the light emitted from the first and/or second light sources 16, 18, and the light beam pattern may generally refer to the beam shape, and optionally a beam angle, as seen when the light is projected onto a surface or surfaces. The one or more first light sources 16 and the one or more second light sources 18 may be light emitting diodes (LEDs). However, other suitable light sources, or combinations of suitable light sources, are also envisioned. For example, another suitable light source includes laser excited phosphor (LEP).

The first and second light sources 16, 18 may be arranged in a predetermined manner, for example, depending on an intended application or type of the lighting device 10. To this end, a quantity, positioning, pattern, or the like, of the first light sources 16, the second light sources 18, or both, may be varied during manufacture. For example, in the embodiment of FIG. 1, a single first light source 16 is shown at a generally central position, and eight second light sources 18 are disposed about the first light source 16 in first configuration.

The present disclosure is not limited to the configuration of the first and second light sources 16, 18 shown and described with reference to the example of FIG. 1. For example, FIG. 2 is a diagram showing the lighting device 10 having an alternative, second configuration of the second light sources 18, to form a second lighting array 13. Other configurations and relative positioning of the first and second light sources 16, 18 are envisioned as well.

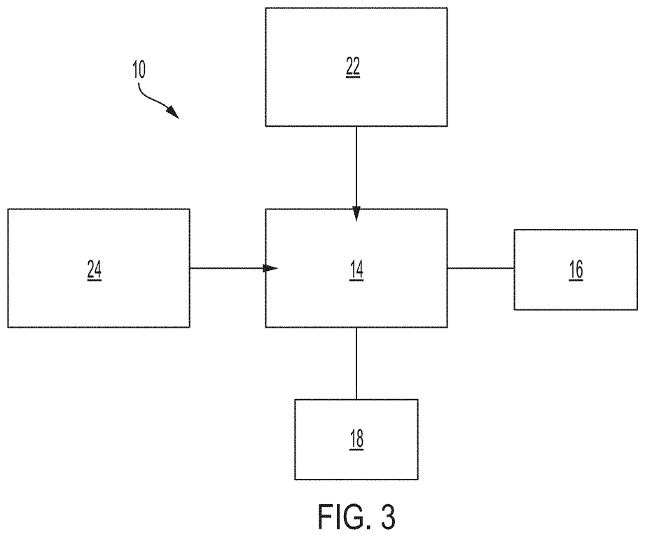

FIG. 3 is a schematic block diagram of the lighting device 10, according to an embodiment. In one embodiment, the lighting device 10 may further include circuitry 14 interconnecting the one or more first light sources 16 and the one or more second light sources 18 with an input device 22 and a power supply 24. In one embodiment, the circuitry 14 may be configured to receive an input signal from the input device 22 and to control power supplied from the power supply 24 to the one or more first light sources 16, one or more second light sources 18, or both, based on the received input signal.

In one embodiment, the circuitry 14 may include a printed circuit board (“PCB”). In one embodiment, the one or more first light sources 16, the one or more second light sources 18, or both, may be mounted on the PCB. Alternatively, or in addition, the circuitry 14 may include a microcontroller having a memory configured to store program instructions, a microprocessor configured to execute the program instructions to control functions of the lighting device 10, and a communication module configured to send and receive signals.

The input device 22 may be any suitable device configured to receive an instruction from a user relating to a desired light beam pattern, and transmit an input signal to the circuitry 14 based on the instruction received from the user. For example, the input device 22 may include a microphone configured to receive a verbal input, a switch, knob, dial, slider, keypad or the like configured to receive a mechanical input, a touchpad, trackpad, touchscreen or the like configured to receive a gesture control, any other known suitable input device, or any suitable combination of the same. In one embodiment, separate input devices 22 may be provided to transmit input signals for the first light sources 16 and the second light sources 18, respectively. In one embodiment, user input may be remotely received in a known manner, for example, by transmitting the input using RF signals, Bluetooth, LiDar and other known, suitable, communication techniques. The power supply 24 may be a battery, for example.

Accordingly, power supplied to one of, or both, the one or more first light sources 16 and the one or more second light sources 18 may be varied to control an output, such as the brightness, of the first and second light sources 16, 18 in a desired manner. By varying power supplied to the one or more first light sources 16, the one or more second light sources 18, or both, the light beam shape produced by the first and second light sources 16, 18 may be electronically varied, based on the input signal, to produce a desired light beam pattern suitable for use in a desired application.

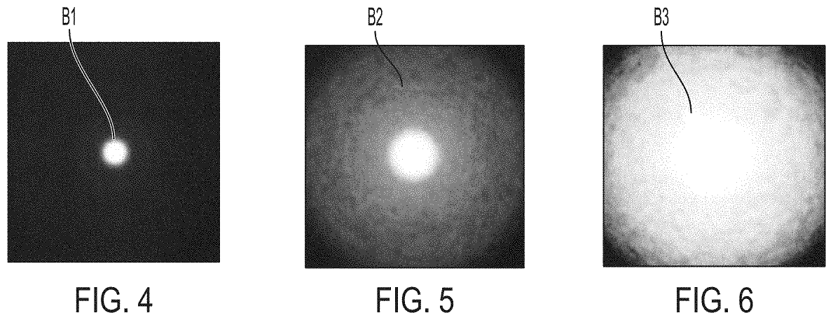

FIGS. 4-6 show examples of different light beam patterns produced by the lighting device 10 which may be achieved by varying power to the one or more first light sources 16, the one or more second light sources 18, or both, in the manner described above. For example, FIG. 4 shows an example of a light beam pattern B1 with 100% power supplied to the first light source 16 to produce a narrow light beam pattern. FIG. 5 shows an example of a light beam pattern B2 with 50% power supplied to the first light source 16 and 50% power supplied to the second light source 18 to produce a combined light beam pattern. FIG. 6 shows an example of a light beam pattern B3 with 30% power supplied to the first light source 16 and 70% power supplied to the second light source 18 to produce a combined light beam pattern having characteristics more commonly associated with a flood light beam pattern. Adjusting or varying power to the first and/or second light sources 16, 18 may vary the light beam shape emitted from the array 12, which in turn, may vary the light beam pattern.

It is understood that the light beam patterns B1-B3 shown and described in FIGS. 4-6 are non-limiting examples, and that other light beam patterns may be produced by supplying power to the first and second light sources 16, 18 in different ratios or amounts to vary the light beam shape. For example, it is envisioned that any combination of power adjustment may be made between the first and second light sources 16, 18, such that power may be provided to the first light source 16 anywhere in the range of 0-100% and to the second light source 18 anywhere in the range of 0-100%. The power provided to the first and second light sources 16, 18 to produce the light beam pattern can be varied in predetermined increments or substantially infinitely varied, by operation of the input device 22 and the circuitry 14, for example. In addition, power may be supplied to individual light sources, or combinations of light sources of the first and second light sources 16, 18 in substantially any desired combination to vary to the light beam pattern produced by the first and second light sources 16, 18.

In one embodiment, the lighting device 10 may include one or more optic devices configured to vary the light beam shape produced by the first and second light sources 16, 18 and thus, may also vary the light beam pattern by directing light emitted from a light source 16, 18 in a predetermined manner. In one embodiment, the one or more optic devices may be configured, for example, to diffract, refract, diffuse, reflect, focus or otherwise alter a beam shape produced by the first and second light sources 16, 18. In one embodiment, the optic device is configured to change a beam angle of the light emitted from one or both of the light sources 16, 18. In one embodiment, different optic devices may be associated with different light sources 16, 18, or with different individual light sources of the one or more first light sources 16 and/or the one or more second light sources 18. In one embodiment, multiple optic devices may be used in combination with one another.

The optic device may include, for example, a reflective surface, a toroid optic, broadening optic, a lens or other similar, suitable device. In one embodiment, the optic device may be disposed in a path of the light emitted from one or more of the first and second light sources 16, 18. Non-limiting examples of suitable optic devices are described in the aforementioned U.S. '122 patent, in which a toroid optic and/or a broadening optic are configured to refract light emitted by an LED.

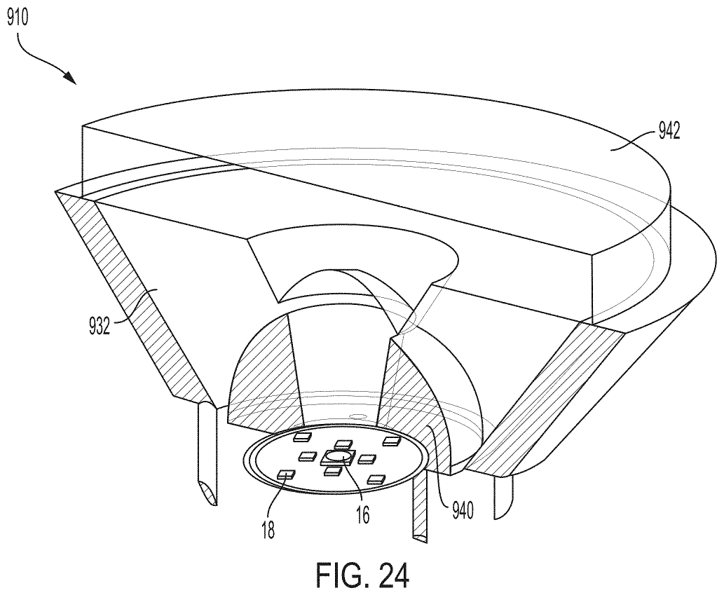

FIG. 24 shows an example of a lighting device 910 having a plurality of optic devices, according to an embodiment. For example, the lighting device 910 may include a first optic device 940, a second optic device 942, and a third optic device 932 disposed relative to first and second light sources 16, 18. In one embodiment, the first optic device 940 may be a toroid optic and the second optic device 942 may be a broadening optic. Alternatively, in one embodiment, the second optic device 942 may be a lens or combination of lenses. In one embodiment, the third optic device 932 may be, for example, a reflector. In one embodiment, the reflector 932 may substantially surround the optic devices 940, 942. Other configurations of the first and second light sources 16, 18 are envisioned as well, including the configurations described in the various embodiments below.

The present disclosure is not limited to the examples described above. For example, in other embodiments, it is envisioned that the light beam shape produced by the first and second light sources 16, 18 may be varied by a combination of electronic control as described above, and mechanical control. The mechanical control may be a known mechanical control operably coupled to the one or more first light sources 16, the one or more second light sources 18, the optic device or devices, or a combination thereof. The mechanical control may be operated to vary the light beam shape produced by the light sources 16, 18, to produce a desired light beam pattern.

In another embodiment, it is envisioned that the light beam pattern may be varied by way of electronic control of the first and second light sources 16, 18 as described above and electronic control of the one or more optic devices to vary the beam shape. In still another embodiment, it is envisioned that the beam pattern may be varied by way of a scanning light beam which is variable to produce desired peripheral light.

In one embodiment, an electronically controlled optic device may include an electronically controlled lens or lenses. Examples of such lenses include liquid lenses and lenses having voltage-sensitive crystalline orientations. The electronically controlled optic device may be operably connected to the power supply 24 via the circuit 14. The electronically controlled optic device may be operated, for example, in response to an input received from the input device 22. For example, in one embodiment, voltage may be selectively applied to an electronically controlled lens from the power supply 24 to change a crystalline orientation of the lens. In this manner, the lens may focus the light emitted from the first and/or second light sources 16, 18 to change the beam shape and produce a desired beam pattern. In another embodiment, the liquid lens may be operated to focus the light emitted from the first and/or second light sources 16, 18 to change the beam shape and produce a desired beam pattern.

In one embodiment, different lenses may be associated with different light sources 16, 18. Thus, beam shapes produced by the first and/or second light sources 16, 18 can be individually varied, or a combined light beam shape produced by the first and/or second sources 16, 18, can be varied to produce a desired light beam pattern. Thus, in embodiments above, a desired light beam pattern may be produced by a combination of electronic control of the one or more first and second light sources 16, 18 and one or more of mechanical control of first and second light sources 16, 18, mechanical control of the one or more optic devices and electronic control of the one or more optic devices.

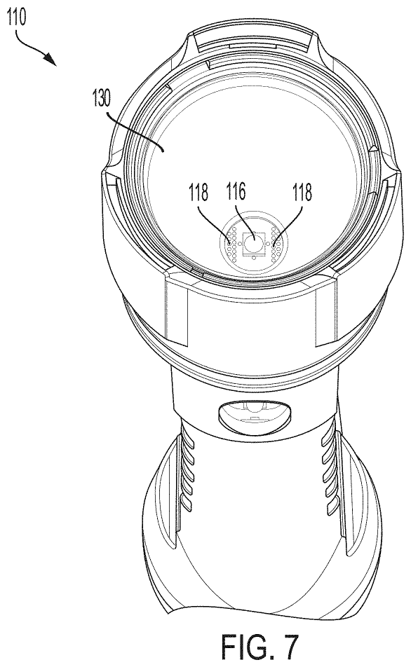

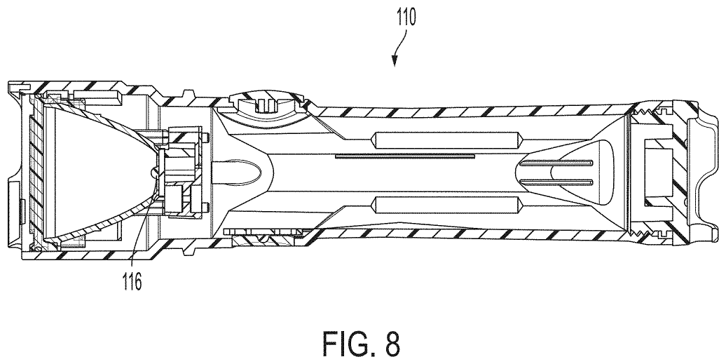

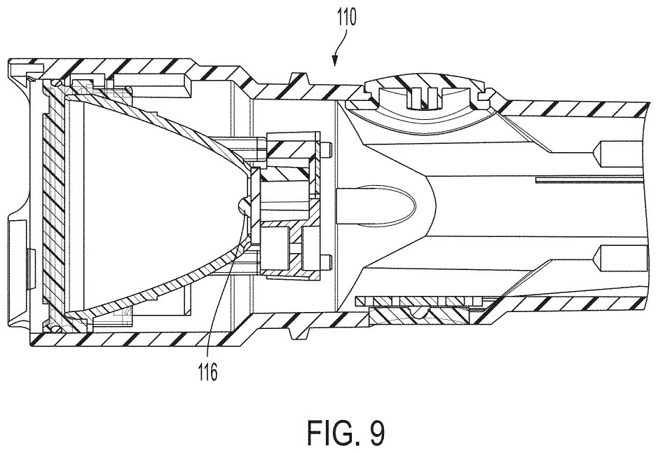

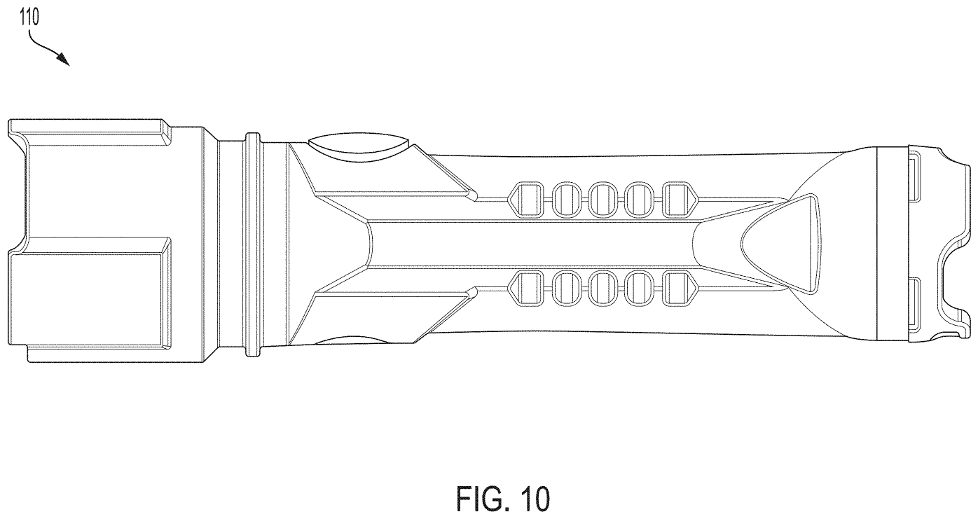

FIGS. 7-22 show various examples of lighting devices configured to produce electronically variable beam patterns according to the embodiments described above. In the embodiments below, description of features which are the same or substantially the same as those described above may be omitted for clarity.

For example, FIGS. 7-10 show various views of a lighting device 110 according to another embodiment. The lighting device 110 may include one or more first light sources 116 and one or more second light sources 118. According to one embodiment, the one or more first light sources 116 may be disposed in a different plane than the one or more second light sources 118. The first and second light sources 116, 118 may be disposed in a chamber 130, for example, of a reflector assembly.

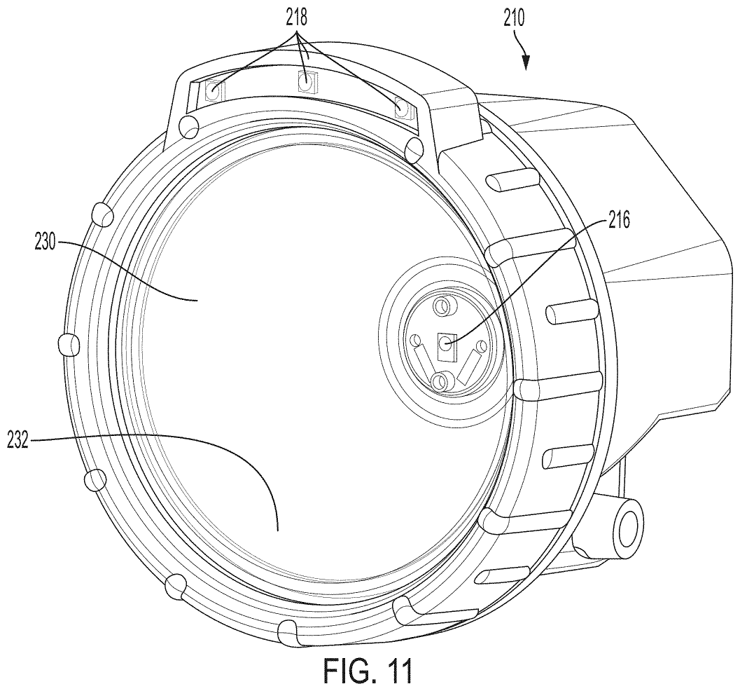

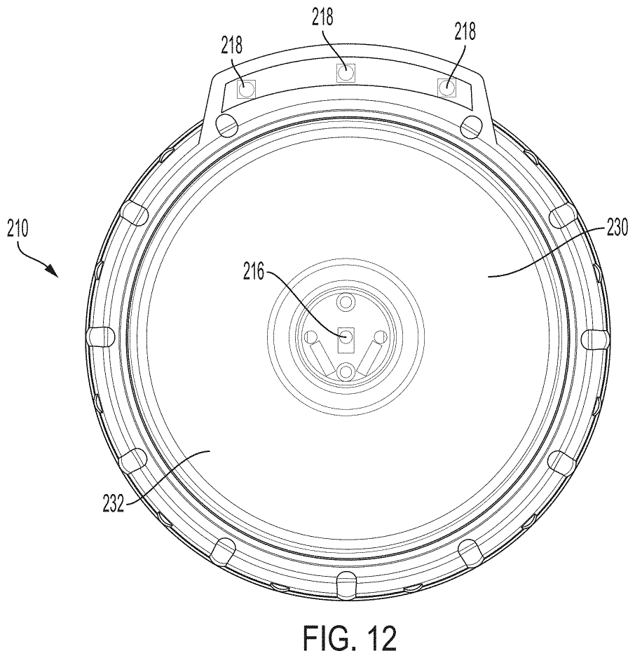

FIGS. 11 and 12 show various views of a lighting device 210 according to another embodiment. The lighting device 210 may include one or more first light sources 216 disposed generally at an inner end of a chamber 230, for example, of a reflector assembly, and one or more second light sources 218 disposed outside of the chamber 230. In one embodiment, the one or more second light sources 218 may extend about a portion of a periphery of the chamber 230. In one embodiment, the lighting device 210 may include a reflector 232 disposed within the chamber 230. Alternatively, or in addition, the lighting device 210 may include one or more optic devices, such as those described above (not shown in FIGS. 11 and 12).

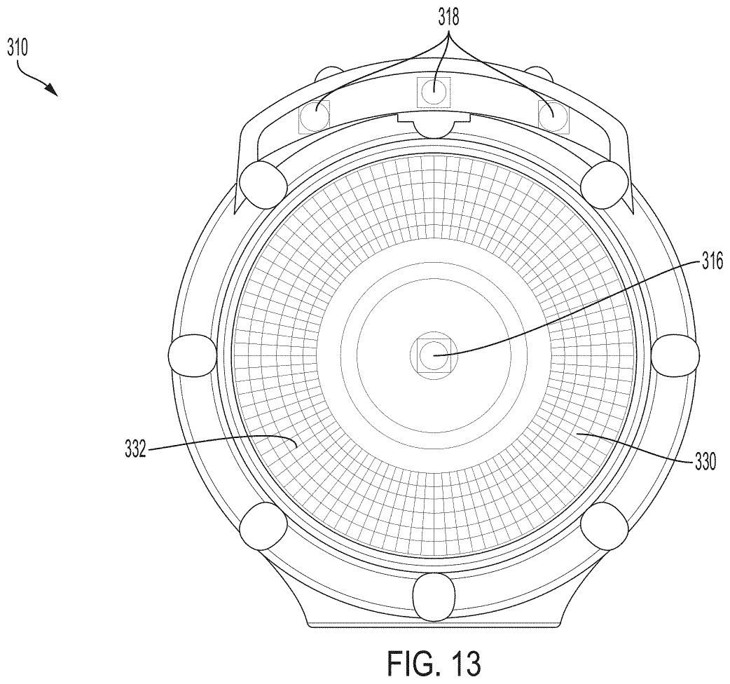

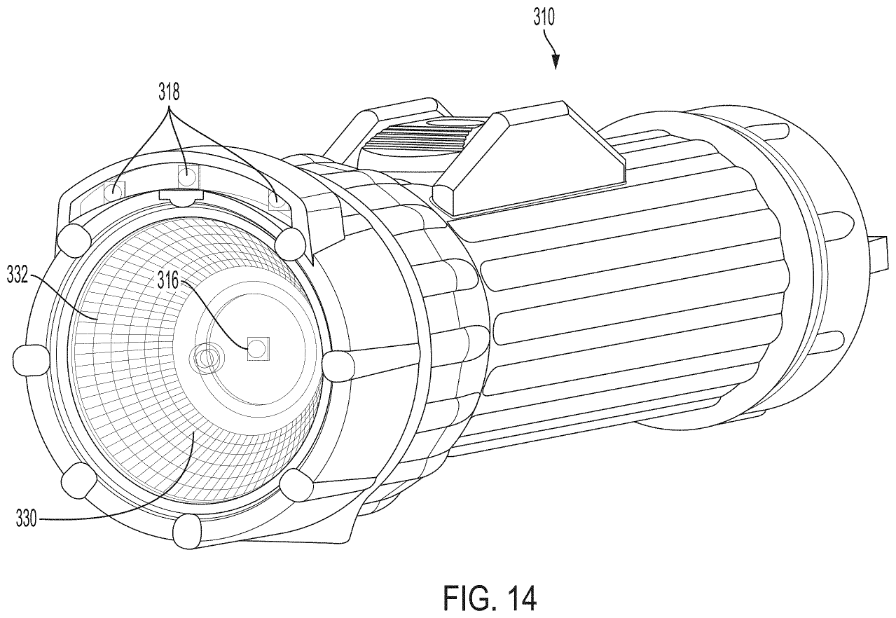

FIGS. 13 and 14 show various views of a lighting device 310 according to another embodiment. The lighting device 310 may include one or more first light sources 316 disposed generally at an inner end of a chamber 330 and one or more second light sources 318 disposed outside of the chamber 330. In one embodiment, the one or more second light sources 318 may extend about a portion of a periphery of the chamber 330. In one embodiment, the lighting device 310 may include a reflector 332 disposed within the chamber 330. Alternatively, or in addition, the lighting device 310 may include one or more optic devices, such as those described above (not shown in FIGS. 13 and 14).

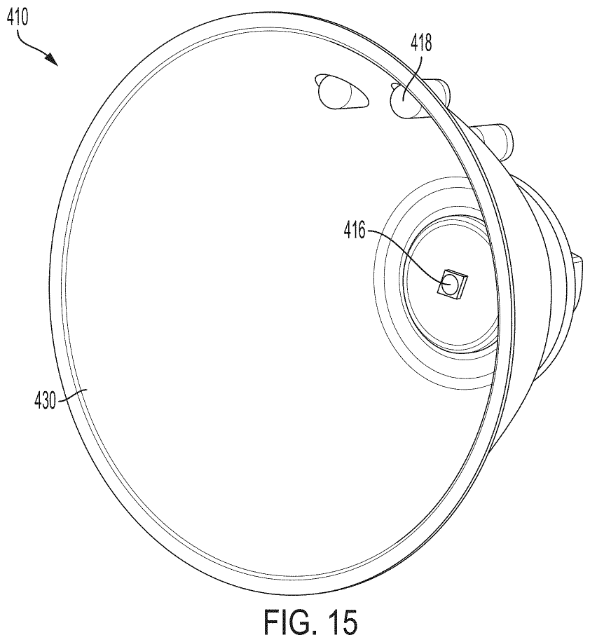

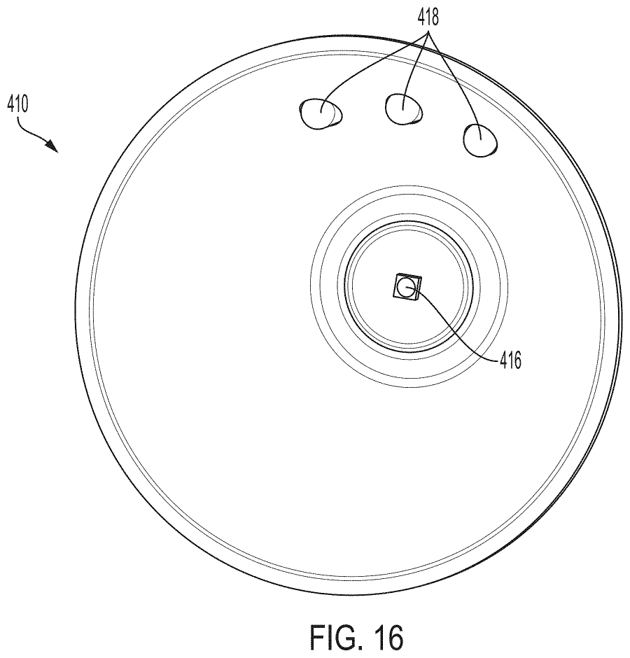

FIGS. 15 and 16 show various views of a lighting device 410 according to another embodiment. The lighting device 410 may include one or more first light sources 416 disposed generally at an inner end of a chamber 430, and one or more second light sources 418 disposed within the chamber 430 at position spaced from the one or more first light sources 416 in a longitudinal direction, between the inner end and an outer end of the chamber 430. In one embodiment, the chamber 430 may be a chamber of a reflector assembly.

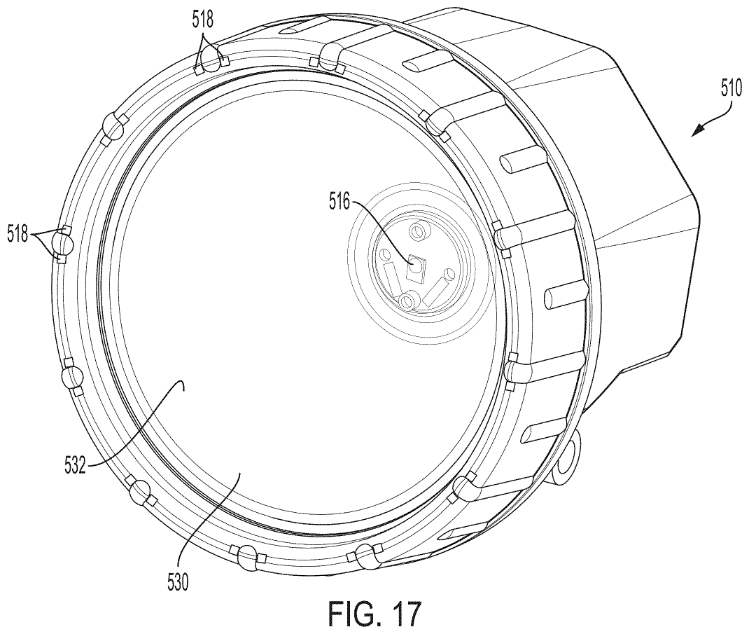

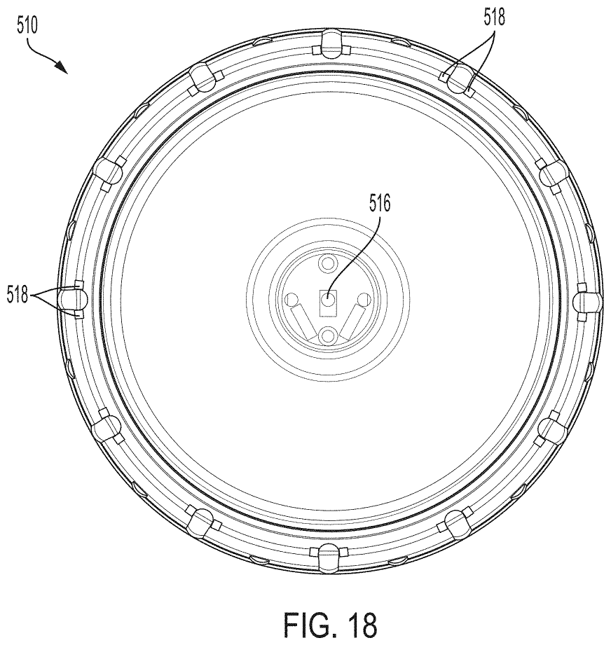

FIGS. 17 and 18 show various views of a lighting device 510 according to another embodiment. The lighting device 510 may include one or more first light sources 516 disposed generally at an inner end of a chamber 530, and one or more second light sources 518 disposed outside of the chamber 530. In one embodiment, the lighting device 510 may include a reflector 532 disposed within the chamber 530. Alternatively, or in addition, the lighting device 510 may include one or more optic devices, such as those described above (not shown in FIGS. 17 and 18). In one embodiment, the one or more second light sources 518 may be disposed in pairs at substantially equal intervals about a periphery of the chamber 530.

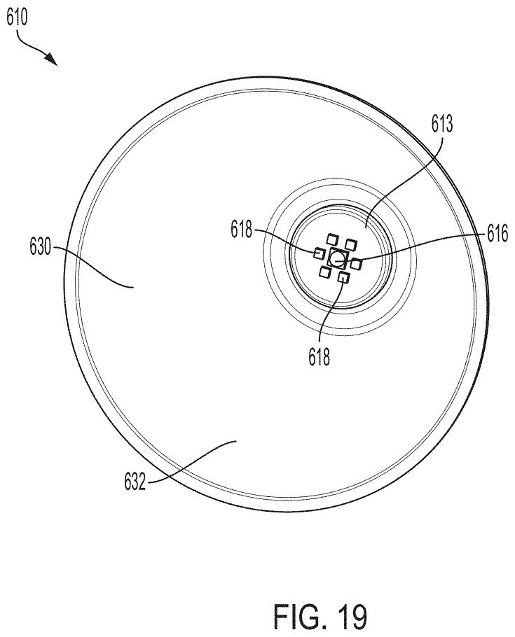

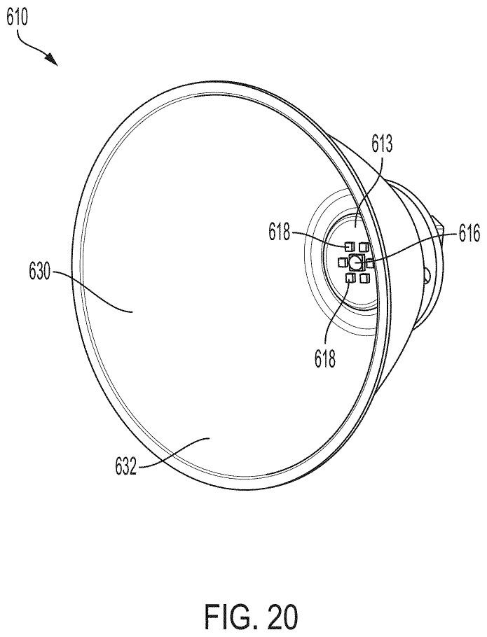

FIGS. 19 and 20 show various views of a lighting device 610 according to another embodiment. The lighting device 610 may include one or more first light sources 616 and one or more second light sources 618 disposed generally at an inner end of a chamber 630. In one embodiment, the first and second light sources 616, 618 may be substantially coplanar with one another. In one embodiment, the first and second light sources 616, 618 may be arranged on a lighting array 613 substantially the same as the lighting array 13 of the embodiment shown in FIG. 2 and described above. For example, the first and second light sources 616, 618 may be disposed on a common PCB. In one embodiment, the lighting device 610 may include a reflector 632 disposed within the chamber 630 and extending from the inner end toward outer end. The chamber 630 may be a chamber of, for example, a reflector assembly. Alternatively, or in addition, the lighting device 610 may include one or more optic devices, such as those described above (not shown in FIGS. 19 and 20).

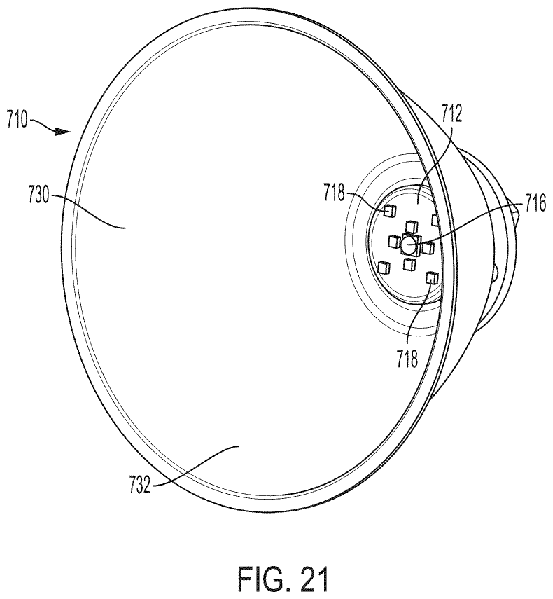

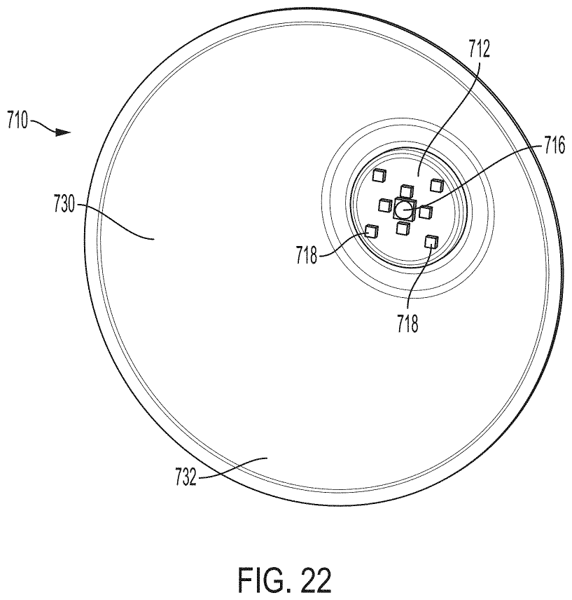

FIGS. 21 and 22 show various views of a lighting device 710 according to another embodiment. The lighting device 710 may include one or more first light sources 716 and one or more second light sources 718 disposed generally at an inner end of a chamber 730. In one embodiment, the first and second light sources 716, 718 may be substantially coplanar with one another. In one embodiment, the first and second light sources 716, 718 may be arranged on a lighting array 712 substantially the same as the lighting array 12 of the embodiment shown in FIG. 1 and described above. For example, the first and second light sources 716, 718 may be disposed on a common PCB. In one embodiment, the lighting device 710 may include a reflector 732, disposed within the chamber 730 and extending from the inner end toward outer end. The chamber 730 may be a chamber of, for example, a reflector assembly. Alternatively, or in addition, the lighting device 710 may include one or more optic devices, such as those described above (not shown in FIGS. 21 and 22).

In the embodiments above, power may be supplied to the one or more first light sources 16 and the one or more second light sources 18 independently, and thus, may be varied at each of the first and second light sources 16, 18 independently, for example by user input at separate input devices 22. Alternatively, the power supplied to one of first light source 16 and the second light source 18 may be dependent on the power supplied to the other of the first light source 16 and the second light source 18. For example, the power supplied to one of the first light source 16 and the second light source 18 may be inversely proportionate to the power supplied to the other of the first light source 16 and the second light source 18.

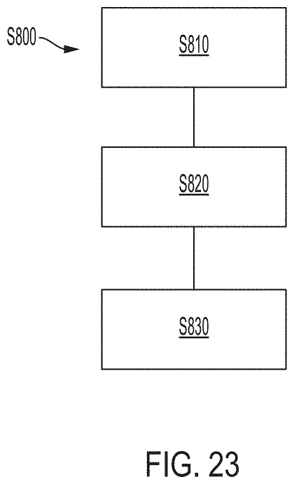

FIG. 23 is a block diagram showing an example of a method S800 of electronically varying a light beam shape to produce a desired light beam pattern by a lighting device. In one embodiment, the method includes, at S810, supplying power to one or more first light sources 16, at S820, supplying power to one or more second light sources 18, and at S830, varying the power supplied to the one or more first light sources, the one or more second light sources, or both. The power supplied to the one or more first light sources 16, the one or more second light sources 18, or both, may be varied in response to receiving an electronic input signal at the circuitry 14 interconnecting the input device 22, the power supply 24, the one or more first light sources 16 and the one or more second light sources 18.

In the embodiments above, a lighting device 10 may include various configurations of the one or more first light sources 16 and the one or more second light sources 18. For example, the first and second light sources 16, 18 may be positioned substantially coplanar with one other, non-coplanar with one another (i.e., at different longitudinal positions along a length of a chamber or in the direction of emitted light), at different radial locations, in different patterns, or combinations thereof. In some embodiments, the one or more first light sources 16 and the one or more second light sources 18 may be mounted to different components of the lighting device 10. The present disclosure is not limited to these examples, and other arrangements of the first and second light sources 16, 18 in a 3D space are envisioned.

In one embodiment, the one or more first light sources 16 and the one or more second light sources 18 may be oriented in the same direction or different directions. For example, the first and second light sources 16, 18 may be oriented to emit light in generally parallel directions relative to one another. Alternatively, the first light sources 16 and the second light sources 18 may be oriented to emit light in directions generally non-parallel relative to one another. Similarly, in one embodiment, at least one light source of the first sources 16 may be oriented in the same direction or a different direction than at least one other light source of the first light sources 16. Likewise, in one embodiment, at least one light source of the second light sources 18 may be oriented in the same direction or a different direction than at least one other light source of the second light sources 18. Thus, in one embodiment, at least one light source of the one or more first light sources or the one or more second light sources and at least one other light source of the one or more first light sources or the one or more second light sources are oriented to emit light beams in substantially non-parallel directions relative to one another. Various combinations of different directions, including multiple different directions, for the first lighting sources 16, second lighting sources 18, or both, are envisioned as well.

The lighting devices described in the embodiments above may be portable lighting devices, such as handheld lighting devices or lighting devices configured to be mounted on or attached to an article of clothing, helmet or other wearable equipment. In one embodiment, such a portable lighting device may be battery powered and include an interface configured to have a battery attached thereto. Such an interface may include, for example, an electrical contact and one or more fasteners or closures to secure the batter to the portable lighting device. Alternatively, or in addition, the portable lighting device can include an interface configured for a wired electrical connection to an external, portable battery. Thus, such a portable lighting device may be used without a wired connection to an external power supply such as a wall outlet or a generator.

Features from any one of the embodiments described above may be implemented in, combined or used together with, or replace features from any of the other embodiments described above.

It is understood the various features from any of the embodiments above are usable together with the other embodiments described herein.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular. In addition, it is understood that terminology referring to orientation of various components, such as “upper” or “lower” is used for the purposes of example only, and does not limit the subject matter of the present disclosure to a particular orientation.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover all such modifications as fall within the scope of the claims.

What is claimed is:

1. An electronically variable lighting device comprising:
a power supply;
an input device;
one or more first light sources;
one or more second light sources; and
circuitry interconnecting the power supply and the input device with the one or more first light sources and the one or more second light sources,
wherein the one or more first light sources and the one or more second light sources are configured to produce a light beam shape for producing a light beam pattern, and
wherein the circuitry is configured to control power supplied from the power supply to the one or more first light sources, the one or more second light sources, or both, to vary the light beam shape.

2. The electronically variable lighting device of claim 1, wherein the circuitry is configured to control power supplied by the power supply to the one or more first light sources, the one or more second light sources, or both, in response to an input signal received from the input device.

3. The electronically variable lighting device of claim 1, wherein the one or more first light sources are configured to produce a central, narrow light beam pattern.

4. The electronically variable lighting device of claim 1, wherein the one or more second light sources are configured to produce a peripheral, flood light beam pattern.

5. The electronically variable lighting device of claim 1, wherein the one or more first light sources are centrally positioned and the one or more second light sources are peripherally positioned relative to the one or more first light sources.

6. The electronically variable lighting device of claim 1, wherein the one or more first light sources and the one or more second light sources are coplanar.

7. The electronically variable lighting device of claim 1, wherein the one or more first light sources and the one or more second light sources are non-coplanar.

8. The electronically variable lighting device of claim 1, further comprising a chamber, wherein the one or more first light sources are positioned inside the chamber and the one or more second light sources are positioned outside of the chamber.

9. The electronically variable lighting device of claim 1, further comprising a chamber, wherein the one or more first light sources and the one or more second light sources are positioned inside the chamber.

10. The electronically variable lighting device of claim 9, further comprising a chamber, wherein the one or more first light sources are spaced from the one or more second light sources in a longitudinal direction of the chamber.

11. The electronically variable lighting device of claim 1, wherein the circuitry includes a printed circuit board.

12. The electronically variable lighting device of claim 1, wherein the circuitry includes a microcontroller.

13. The electronically variable lighting device of claim 1, wherein power is supplied to the one or more first light sources and the one or more second light sources independently of one another.

14. The electronically variable lighting device of claim 1, wherein power supplied to the one or more first light sources is inversely proportional to power supplied to the one or more second light sources.

15. The electronically variable lighting device of claim 1, wherein the one or more first light sources, the one or more second light sources, or both, are light emitting diodes.

16. The electronically variable lighting device of claim 1, wherein the one or more first light sources, the one or more second light sources, or both, are laser excited phosphor.

17. The electronically variable lighting device of claim 1, further comprising one or more optic devices configured to direct a light beam produced by the one or more first light sources, the one or more second light sources, or both.

18. The electronically variable lighting device of claim 17, wherein the optic device is a reflector configured to reflect a light beam produced by the one or more first light sources, the one or more second light sources, or both.

19. The electronically variable lighting device of claim 17, wherein the optic device is a lens.

20. The electronically variable lighting device of claim 19, wherein the lens is an electronically controlled lens.

21. The electronically variable lighting device of claim 17, further comprising a mechanical control operably coupled to the one or more first light sources, the one or more second light sources, the one or more optic devices or a combination thereof, wherein the mechanical control is operable to vary the light beam pattern.

22. The electronically variable lighting device of claim 1, wherein at least one light source of the one or more first light sources or the one or more second light sources and at least one other light source of the one or more first light sources or the one or more second light sources are oriented to emit light beams in substantially non-parallel directions relative to one another.

23. A method of electronically varying a light beam shape to produce a desired light beam pattern by a lighting device, the method comprising:
supplying power to one or more first light sources;
supplying power to one or more second light sources; and
varying the power supplied to the one or more first light sources, the one or more second light sources, or both.
